(19) United States
(12) Patent Application Publication
(10) Pub. No.: US 2009/0243874 A1
(43) Pub. Date: Oct. 1, 2009

(54) Electronic device, computer-readable medium storing program to control electronic device, and remote control giving instructions to electronic device

(75) Inventor: Tomohiro Sato, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/382,809

(22) Filed: Mar. 24, 2009

(30) Foreign Application Priority Data
Mar. 27, 2008 (JP) 2008-082359

(51) Int. Cl. G05B 19/02; G06F 7/04

(52) U.S. Cl. 340/825.22; 340/5.81

(57) ABSTRACT

An electronic device that accepts instructions from remote controls includes a user identification information obtaining device, a remote control user storage device, and an association device. The user identification information obtaining device obtains user identification information to identify a user from a user identification information storage medium. The remote control user storage device stores the user identification information of remote control users respectively associated with remote control identification information of the remote controls. The association device stores the obtained user identification information into the remote control user storage device, in a condition where the obtained user identification information is associated with the remote control identification information of any one of the remote controls.

### CROSS-REFERENCE TO RELATED APPLICATION

This application claims priority to Japanese Patent Application No. 2008-082359, filed Mar. 27, 2008, the disclosure of which is hereby incorporated by reference in its entirety.

### BACKGROUND

The present disclosure relates to an electronic device that receives instructions from a remote control, a computer-readable medium storing a program to control an electronic device, and a remote control that gives instructions to the electronic device.

Conventionally, a remote control may be used to give instructions to an electronic device from a point distant from the electronic device. An example may be a remote control that gives instructions to an electronic device such as a television or an air conditioner. Among those electronic devices, some electronic devices may be associated with a plurality of remote controls, rather than one remote control. For example, according to a program control device in an audio visual apparatus disclosed in Japanese Patent Application Laid-Open Publication No. 2004-153702, a plurality of remote controls are each assigned with a fixed remote control ID. The remote control ID is used to identify which one of the remote controls has sent an operation signal. Each of the plurality of remote controls may be considered to be used exclusively by a user. Accordingly, each remote control ID may be regarded as an ID of each user. Furthermore, among the plurality of remote controls, only one of the remote controls may have the right to control the audio visual apparatus. Further, if a user wishes to use any other user's remote control, the user may enter a user ID and a password to the remote control. If the entered user ID and password respectively match a user ID and a password stored beforehand, a remote control ID will be issued corresponding to the new user.

### SUMMARY

According to the program control device described above, a remote control ID may be regarded as a user ID. Therefore, in a case where a plurality of users share one remote control, the program control device may fail to accurately recognize which one of the users is actually using the remote control. Moreover, because only one of the remote controls has the right to control the program control device, the program control device may not accept instructions from the plurality of remote controls. Further, in a case where a user wishes to use a remote control and enters a user ID and a password to the remote control in order to change the remote control user, the user can not use the remote control as the user's own unless the user ID and the password are stored beforehand in the remote control. In other words, the user can use only a remote control in which the user ID and the password of the user's own are stored beforehand. Therefore, if users who can use the remote controls are not predetermined for each remote control, it may be impossible for the program control device to distinguish the users who are actually using the remote controls from one another.

Various exemplary embodiments of the general principles described herein provide an electronic device that accepts instructions from a plurality of remote controls and identifies users who are using the respective remote controls, a computer-readable medium storing a program to control an electronic device to cause a computer to function as the electronic device, and a remote control that gives instructions to the electronic device.

Exemplary embodiments provide an electronic device that accepts instructions from remote controls. The electronic device includes a user identification information obtaining device, a remote control user storage device, and an association device. The user identification information obtaining device obtains user identification information to identify a user from a user identification information storage medium that stores the user identification information. The remote control user storage device stores the user identification information of remote control users respectively associated with remote control identification information of the remote controls. The remote control users are users who are respectively using the remote controls, and the remote control identification information identifies each of the remote controls. The association device stores the user identification information obtained by the user identification information obtaining device into the remote control user storage device, in a condition where the obtained user identification information is associated with the remote control identification information of any one of the remote controls.

Exemplary embodiments also provide a remote control that includes an instruction output device to give instructions to the electronic device.

Exemplary embodiments further provide a computer-readable medium storing a program to control an electronic device equipped with remote controls. The program includes instructions to cause a controller of the electronic device to perform the steps of obtaining user identification information, and storing the obtained user identification information to identify a user into a remote control user storage device. In the step of storing the obtained user identification information into a remote control user storage device, the obtained user identification information is stored as associated with remote control identification information of any one of the remote controls. The remote control user storage device stores the user identification information of remote control users respectively associated with the remote control identification information of the remote controls. The remote control users are users who are respectively using the remote controls. The remote control identification information identifies each of the remote controls.

### BRIEF DESCRIPTION OF THE DRAWINGS

Exemplary embodiments will be described below in detail with reference to the accompanying drawings in which:

FIG. 1 is a system configuration diagram showing a configuration of a remote-control control system;

FIG. 2 is an illustration showing an example of a screen on which pointers are displayed based on instructions from remote controls;

FIG. 3 is a block diagram showing an electric configuration of the remote-control control apparatus;

FIG. 4 is an explanatory diagram showing an example of a configuration of a remote-control association information storage area arranged in a hard disk drive of the remote-control control apparatus;

FIG. 5 is a block diagram showing an electric configuration of a server of the remote-control control system;

FIG. 6 is an explanatory diagram showing an example of a configuration of a user information storage area arranged in a hard disk drive of the server;

FIG. 7 is a block diagram showing an electric configuration of a remote control;

FIG. 8 is a flowchart of remote-control association processing;

FIG. 9 is a flowchart of a pointer display processing;

FIG. 10 is a flowchart of logout processing;

FIG. 11 is an illustration of another example of a screen on which pointers are displayed based on instructions from remote controls according to a modified embodiment;

FIG. 12 is a flowchart of the remote-control association processing according to the modified embodiment; and

FIG. 13 is a flowchart of the remote-control association processing according to another modified embodiment.

### DETAILED DESCRIPTION OF THE EXEMPLARY EMBODIMENTS

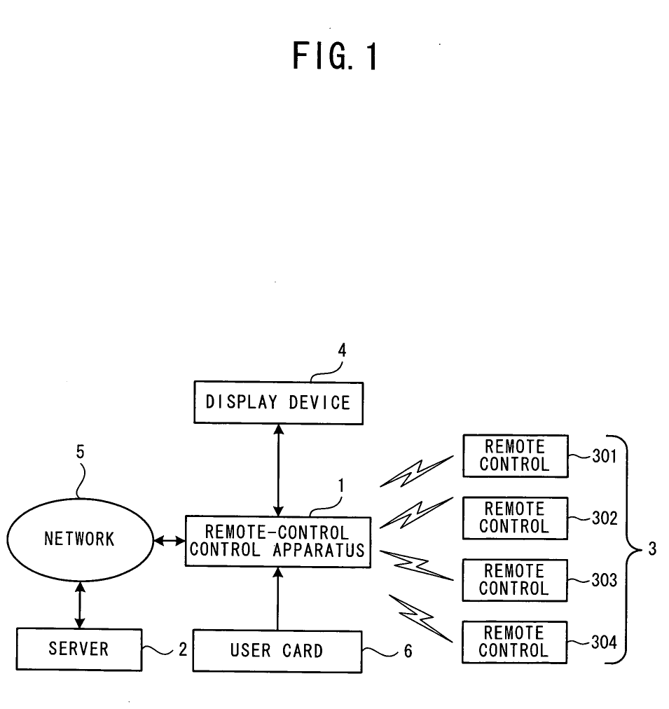

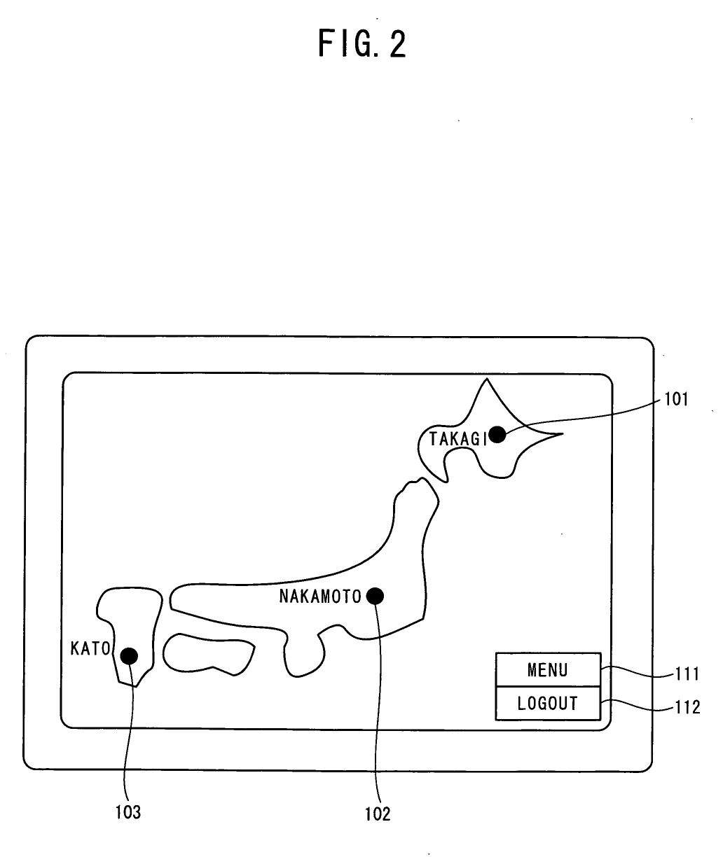

An exemplary embodiment will be described below with reference to the drawings. First, a remote-control control system 100 of the present embodiment will be described, with reference to FIGS. 1 and 2. In the present embodiment, a remote-control control apparatus 1 is connected to a display device 4 equipped with a large-size display. The remote-control control apparatus 1 may receive instructions from a plurality of remote controls 301 to 304. In the present embodiment, an example employing four remote controls will be described. However, the number of the remote controls is not limited to four. The “remote control(s) 3” hereinafter refers to the remote controls 301 to 304 collectively, or an unspecified one of the remote controls 301 to 304.

The remote control 3 outputs position information and a remote control ID of the remote control 3 to the remote-control control apparatus 1 periodically (for example, every 20 milliseconds). The remote control ID serves as identification information to identify each remote control 3. Based on the position information received from the remote control 3, the remote-control control apparatus 1 causes the display device 4 to display an icon on the display. As shown in FIG. 2, a plurality of icons may be displayed on the screen. For example, in FIG. 2, circular icons are displayed. In the example, three remote controls 3 are in use, and three icons 101 to 103 corresponding to the three remote controls 3 are displayed. In the vicinity of the icons 101 to 103, names of users who are operating the icons are respectively displayed. Therefore, a viewer may recognize which one of the users is operating which one of the icons with the remote control 3.

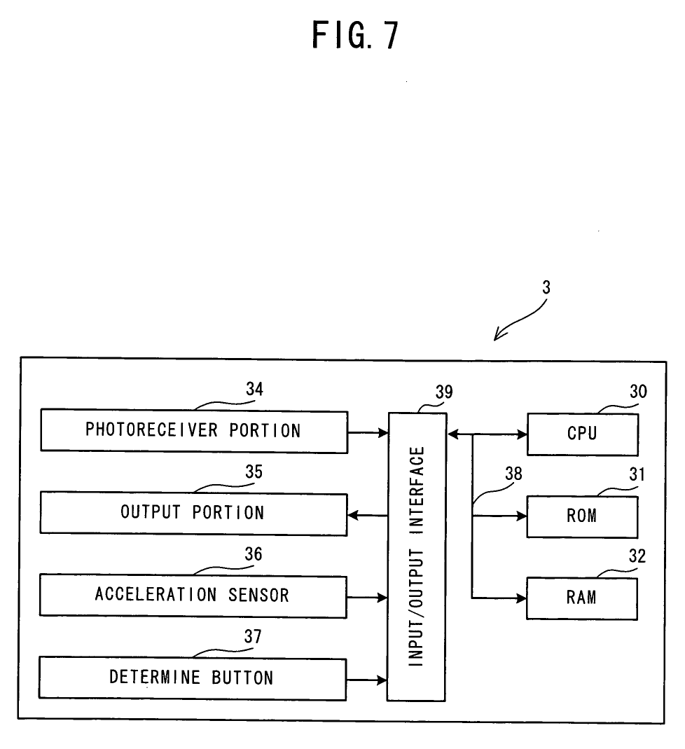

If a user points the remote control 3 at a position where an instruction button is displayed on the screen and presses a DETERMINE button 37 (see FIG. 7), it is assumed that instructions to select the instruction button is given. In the example shown in FIG. 2, a MENU button 111 and a LOGOUT button 112 are provided on the screen. If the user points the remote control 3 at the screen, positions a pointer on the MENU button 111 and then presses the DETERMINE button 37, it is assumed that the MENU button 111 is selected by the remote control 3 operating the pointer. Consequently, a menu screen may appear. If the user points the remote control 3 at the LOGOUT button 112, positions the pointer on the button and then presses the DETERMINE button 37, the user who is using the remote control 3 will be logged out.

The remote-control control apparatus 1 is connected to a server 2 via a network 5. The network 5 may be a LAN or a network such as the Internet. The server 2 stores information on users, such as a user ID and a name of the user. The names may be displayed on the screen based on the information stored in the server 2.

A user card 6 stores a user ID to identify the user. When using the remote control 3, the user holds the user card 6 over the remote-control control apparatus 1 to cause the remote-control control apparatus 1 to read the user ID. The remote-control control apparatus 1 notifies the user of any remote control 3 that is not used. If the user picks up the notified remote control 3, a signal indicating that the remote control 3 has been held is output from the remote control 3 to the remote-control control apparatus 1. Then, the remote-control control apparatus 1 assigns the user to the unused remote control 3 notified of by the remote-control control apparatus 1. Thus, the remote control 3 and the user can be associated with each other.

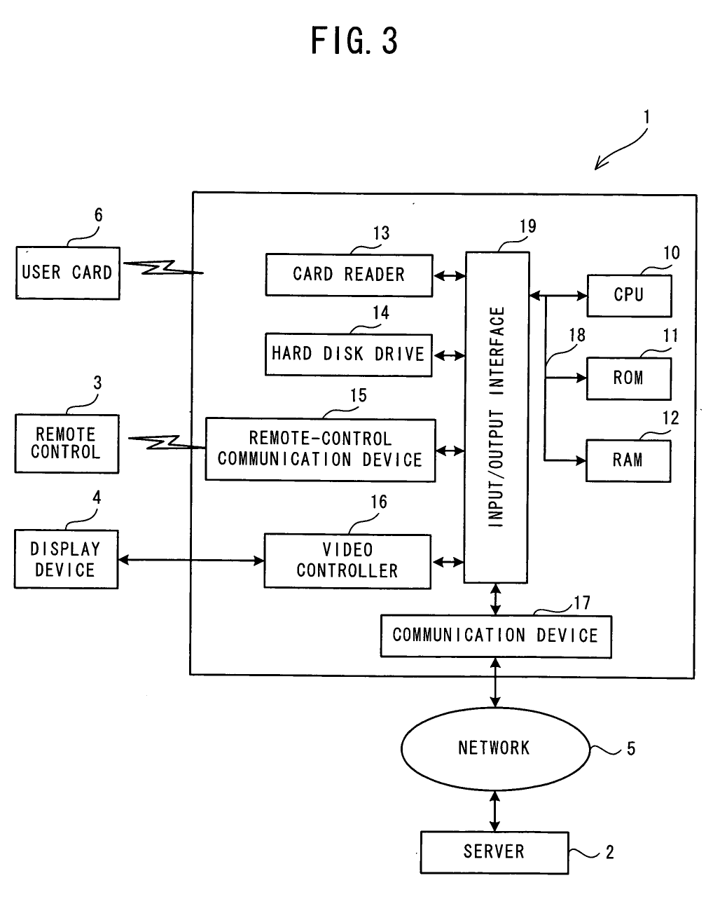

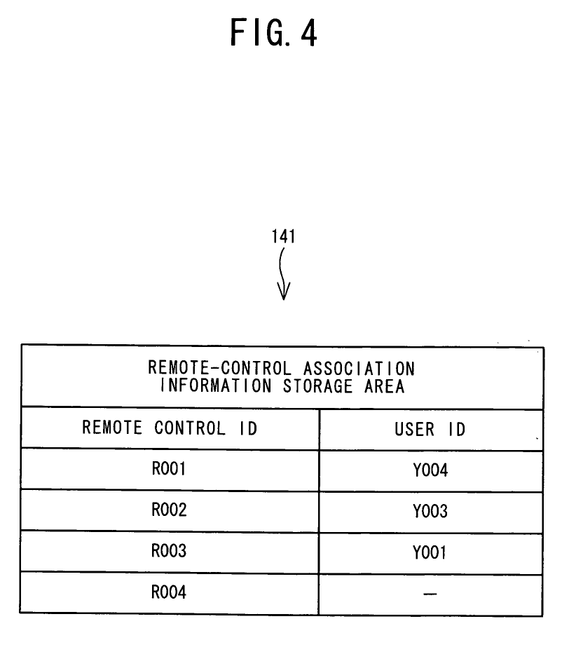

Next, an electric configuration of the remote-control control apparatus 1 will be described with reference to FIGS. 3 and 4. As shown in FIG. 3, the remote-control control apparatus 1 includes a CPU 10 to control the remote-control control apparatus 1, a ROM 11, a RAM 12, and an input/output interface 19, which are connected to each other via a bus 18. A card reader 13, a hard disk drive 14, a remote-control communication device 15, a video controller 16, and a communication device 17 are each connected to the input/output interface 19.

The card reader 13 is equipped with an RF (Radio Frequency) circuit. The card reader 13 transmits an interrogation wave to an RFID (Radio Frequency Identification) tag, receives a reflected wave reflected by the RFID tag, and analyzes the reflected wave, thus extracting information. An RFID tag storing the user ID is embedded in the user card 6. If the user brings the user card 6 near an antenna connected to the RF circuit in the card reader 13, the interrogation wave transmitted from the card reader 13 is received by the user card 6. The user card 6 then transmits the reflected wave that carries the stored user ID. The remote-control communication device 15, which is equipped with an infrared receiver circuit, analyzes a signal output from the remote control 3, thus extracting information. The video controller 16, to which the display device 4 is connected, controls the display device 4 to display information thereon. The communication device 17 controls connecting the remote controller 1 to the server 2 via the network 5.

The ROM 11 stores various control programs to operate the remote-control control apparatus 1 and various values to be used by the control programs. The RAM 12 temporarily stores information to be used by the various control programs. The hard disk drive 14 has at least a remote-control association information storage area 141 (see FIG. 4). A remote control ID and a user ID are associated with each other and stored in the remote-control association information storage area 141.

As shown in FIG. 4, data items of a “remote control ID” and a “user ID” are provided in the remote-control association information storage area 141. The data item of “remote control ID” stores remote control IDs, which are identification information of the remote controls 3 that can be used for the remote-control control apparatus 1. In an example shown in FIG. 4, the remote control IDs of four remote controls, that is, “R001”, “R002”, “R003”, and “R004” are registered. The data item “User ID” stores user IDs respectively associated with the remote control IDs. The user IDs are identification information of users associated with the respective remote controls. In the example shown in FIG. 4, the user ID of “Y004” is associated with the remote control ID of “R001”. The user ID of “Y003” is associated with the remote control ID of “R002”. The user ID of “Y001” is associated with the remote control ID of “R004”. No user ID is assigned to the remote control ID of “R003”. Hereinafter, the remote control 3 having a remote control ID associated with no user ID is referred to as an “unassociated remote control” and the remote control 3 having a remote control ID associated with a user ID is referred to as an “in-use remote control”.

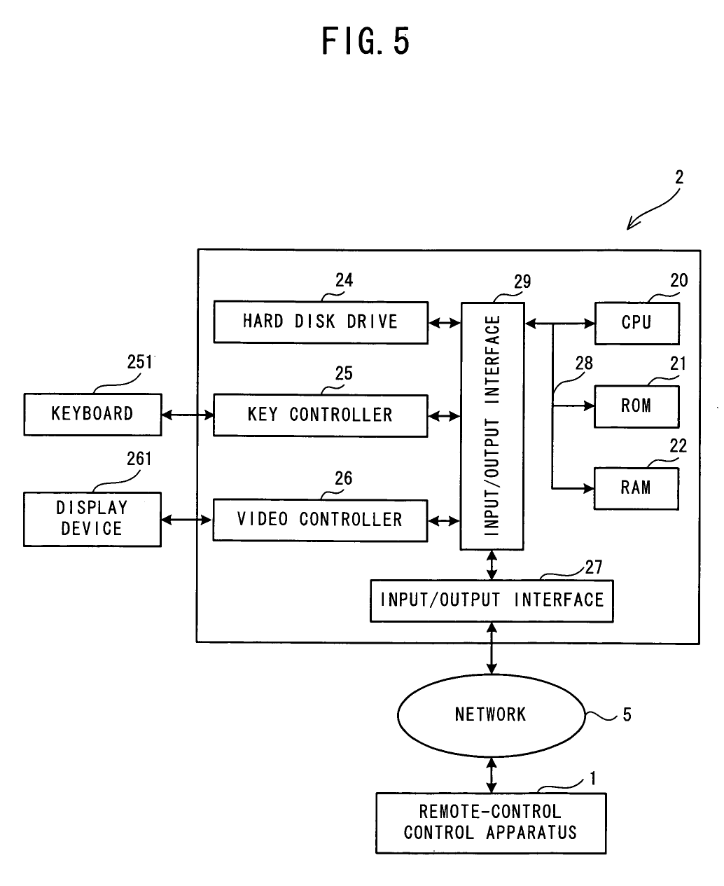

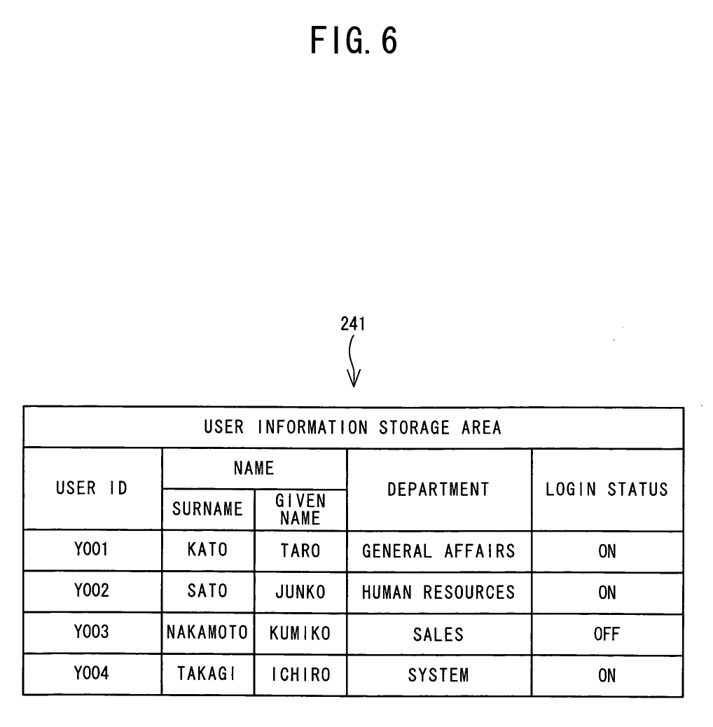

Next, an electric configuration of the server 2 will be described, with reference to FIGS. 5 and 6. As shown in FIG. 5, the server 2 includes a CPU 20 that controls the server 2, a ROM 21, a RAM 22, and an input/output interface 29, which are connected to each other via a bus 28. A hard disk drive 24, a key controller 25, a video controller 26, and a communication device 27 are each connected to the input/output interface 29. A keyboard 251 is connected to the key controller 25 that accepts inputs from the keyboard 251. A display device 261 is connected to the video controller 26 that controls the display device 261 to display information. The communication device 27 controls connecting of the server 2 to the remote-control control apparatus 1 via the network 5.

The ROM 21 stores various control programs to operate the server 2 and various values to be used by the control programs. The RAM 22 temporarily stores information to be used by the various control programs. The hard disk drive 24 has at least a user information storage area 241 (see FIG. 6) that stores information about users. The information about a user is hereinafter referred to as “user information”. As shown in FIG. 6, the user information storage area 241 has data items of a “user ID”, “name”, “department”, and “login status”. Corresponding to the user ID, values indicating the name, the department and the login status are stored. The data item of “name” includes sub-items “surname” and “given name”. In an example shown in FIG. 6, a user with a user ID of “Y001” has a surname of “Kato” and a given name of “Taro”, belongs to a department of “General affairs”, and a login status of the user is “ON”. A user with a user ID of “Y002” has a surname of “Sato” and a given name of “Junko”, belongs to a department of “Human resources”, and a login status of the user is “ON”. A user with a user ID of “Y003” has a surname of “Nakamoto” and a given name of “Kumiko”, belongs to a department of “Sales”, and a login status of the user is “OFF”. A user with a user ID of “Y004” has a surname of “Takagi” and a given name of “Ichiro”, belongs to a department of “System”, and a login status of the user is “ON”.

Next, an electric configuration of the remote control 3 will be described below with reference to FIG. 7. As shown in FIG. 7, the remote control 3 includes a CPU 30 to control the remote control 3, a ROM 31, a RAM 32, and an input/output interface 39, which are connected to each other via a bus 38. A photoreceiver portion 34, an output portion 35, an acceleration sensor 36, and a DETERMNINE button 37 are each connected to the input/output interface 39. The photoreceiver portion 34 detects light emitted from a light emitting portion mounted below the display of the display device 4, and analyzes a position of a light source. The output portion 35 transmits a signal to the remote-control control apparatus 1 utilizing infrared light. The acceleration sensor 36 is a known sensor configured to detect movement of the remote control 3. The DETERMINE button 37 is an input device of the remote control 3.

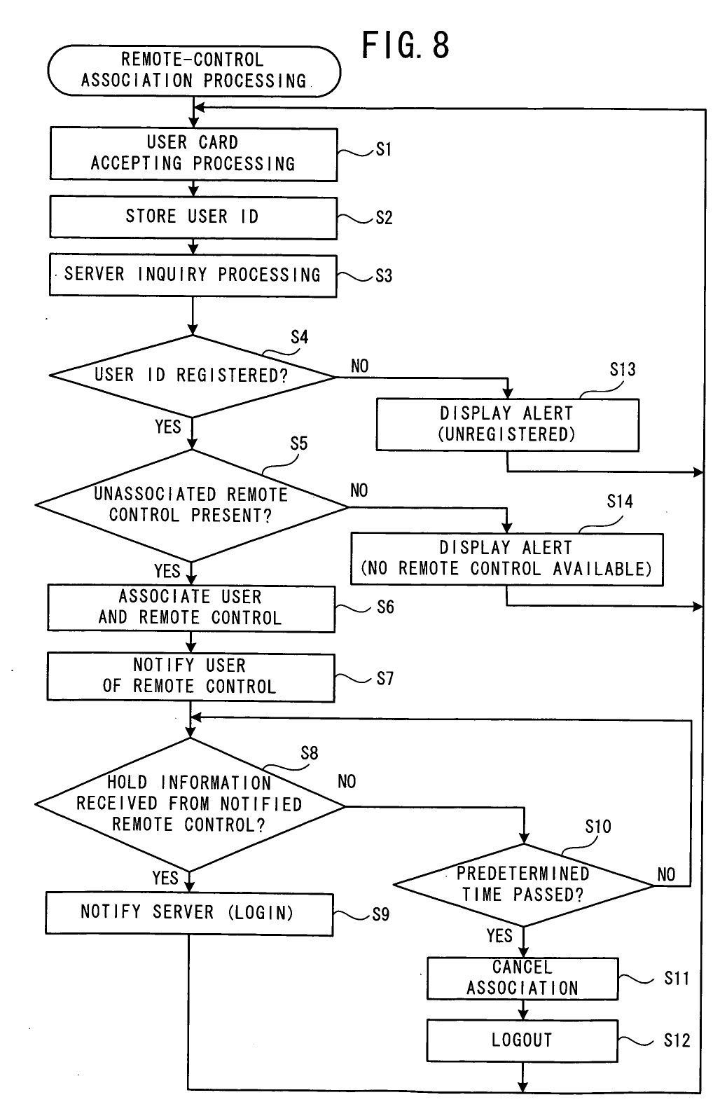

Next, remote-control association processing will be described with reference to FIG. 8. The remote-control association processing is performed by the CPU 10 in the remote-control control apparatus 1 executing a remote-control association program. The remote-control association processing is performed after the remote-control control apparatus 1 is turned on and initialized.

First, processing of accepting a user card is performed (S1). The CPU 10 waits until a user ID is obtained through RF communication between the card reader 13 and the user card 6. The card reader 13 periodically transmits an interrogation wave. If the user card 6 is present in an effective range of the interrogation wave, a reflected wave is transmitted by the RFID tag in the user card 6 and received by the card reader 13. From the received reflected wave, the user ID that was stored in the RFID tag beforehand is extracted and transmitted to the CPU 10. The user ID thus accepted is hereinafter referred to as an “accepted user ID”. After the user ID is obtained from the card reader 13 in the user card accepting processing (S1), the accepted user ID is stored in a predetermined storage area of the RAM 12 (S2).

Subsequently, server inquiry processing is performed (S3). In the server inquiry processing, the obtained user ID is transmitted to the server 2. The server 2 determines whether the transmitted user ID is stored in the user information storage area 241. If the transmitted user ID is stored in the user information storage area 241, the server 2 sets thelogin status of the relevant user as “Interim” and transmits response information of “Registered” to the remote-control control apparatus 1. If the transmitted user ID is not stored in the user information storage area 241, the server 2 transmits response information of “Unregistered” to the remote-control control apparatus 1. The remote-control control apparatus 1 receives either “Registered” or “Unregistered” as the response information from the server 2.

It is determined whether the response information of “Registered” is received from the server 2 (S4). If the received response information is not “Registered” (NO at S4), a message saying “User ID is not registered”, for example, appears as an alert on the display device 4 (S13). Then, the processing returns to step S1 and the user card accepting processing is performed (S1). If the received response information is “Registered” (YES at S4), it is determined whether there is any unassociated remote control (S5). Specifically, the remote-control association information storage area 141 is referenced to determine whether there is any remote control ID to which no user ID is associated.

If there is no remote control ID to which no user ID is associated, all the remote controls 3 are already associated with users, that is, no unassociated remote control is present (NO at S5). Therefore, a message saying “No remote control is available”, for example, appears as an alert on the display device 4 (S14). Then, the processing returns to step S1 and the user card accepting processing is performed (S1). If there is any remote control ID to which no user ID is associated, it is determined that there is an unassociated remote control (YES at S5). Therefore, a user indicated by the user card 6 is associated with the unassociated remote control (S6). Specifically, in the remote-control association information storage area 141, the accepted user ID is stored as a user ID associated with any one of the remote control IDs to which no user ID is associated yet. In the example shown in FIG. 4, the accepted user ID will be stored as a user ID associated with the remote control ID of “R004”.

The user is notified of the unassociated remote control which has newly been associated with the user at step S6 (S7). An unassociated remote control to be notified of to the user is hereinafter referred to as a “notified remote control”. To notify the user of the unassociated remote control, for example, a remote control ID may be displayed on the display device 4. Alternatively, names may be associated with the respective remote control IDs and stored beforehand to make it easier for the user to identify the remote controls. In such a case, the name of the notified remote control may be displayed. The names may be, for example, symbols “A” and “B”, numbers “1” and “2”, nicknames, etc. Further, the remote control 3 may be equipped with a lamp. In such a case, the lamp of the notified remote control may be turned on to notify the user. In this case, the remote-control control apparatus 1 may output a notification instruction signal to the remote control 3, and the remote control 3 may turn on the lamp when the remote control 3 has received the notification instruction signal.

By thus notifying a new user of an unassociated remote control, the user can know which one of the remote controls 3 is available. Therefore, it may be possible to prevent the user from trying to use a remote control 3 another user is already using. As described above, by notifying the user of one of the remote controls 3 as a notified remote control, the remote-control control apparatus 1 can specify which one of the remote controls is to be used by the user. On the other hand, the user may be notified of a plurality of the remote controls 3 not in use. In such a case, the user can select any one of the notified remote controls.

Subsequently, it is determined whether hold information transmitted from the notified remote control is received (S8). The hold information refers to information that indicates that the remote control 3 has been held. If the acceleration sensor 36 in the remote control 3 has detected a movement of the remote control 3, it is determined that the user has held the remote control 3, and the hold information is transmitted to the remote-control control apparatus 1. If the hold information is not received by the remote-control control apparatus 1 (NO at S8), it is determined whether a predetermined time (for example, 30 seconds) has passed since the user was notified of the notified remote control (S10). If the predetermined time has not yet passed (NO at S10), the processing returns to step S8 to determine whether the hold information is received (S8).

If the hold information from the notified remote control is received by the remote-control control apparatus 1 during the repeated processing of steps S8 and S10 (YES at S8), it may be understood that the notified remote control has been held by the user. Then, the accepted user ID is associated with the notified remote control and use information is transmitted to the server 2 (S9). The use information refers to information which indicates that the notified remote control has entered the in-use state. When the use information is received on the server 2, the login status of the user is turned “ON”. It should be noted that thelogin status was stored as “Interim” in the user information storage areas 241 in accordance with the preceding server inquiry processing (S3). After the use information is transmitted to the server 2 (S9), the processing returns to step S1 and the user card accepting processing is performed (S1).

If the hold information from the notified remote control is not received within the predetermined time (NO at S8 and YES at S10), in the remote-control association information storage area 141, the stored user ID associated with the remote control ID of the notified remote control is cleared (S11). Then, logout information for the accepted user ID is transmitted to the server 2 (S12). When the server 2 receives the logout information, the server 2 turns “OFF” the login status of the user stored as “Interim” in the user information storage area 241. After the logout information is transmitted to the server 2 (S12), the processing returns to step S1, to perform the user card accepting processing (S1).

If the user card 6 is thus accepted, it is determined whether the user of the user card 6 can be identified as a user registered in the server 2. If the user is identified as a registered user, an unassociated remote control is newly associated with the user and the user is notified of the unassociated remote control. If it is detected that the user has held the notified remote control, the server 2 is notified that the notified remote control has entered the in-use state. When having received the notification (use information), the server 2 completes a login process of the user. In such a manner, by accepting the user card 6, that is, by obtaining the user ID, the user may be logged in. It is thus possible to manage the use status of the remote controls 3 by the users.

As described above, the remote-control control apparatus 1 that may receive instructions from a plurality of the remote controls 3 obtains a user ID from the user card 6. The remote-control control apparatus 1 then stores the obtained user ID in the remote-control association information storage area 141 in a condition where the user ID is associated with the remote control ID. It is thus possible to assign a remote control 3 with which no user is associated to the user who tries to use one of the remote controls 3. As a result, the remote-control control apparatus 1 can recognize which one of the users is operating the remote control 3. Therefore, instructions from the remote controls 3 can be utilized for processing in accordance with the respective users. For example, the instructions may be grouped into the instructions permitted and the instructions unpermitted for each user, and the remote-control control apparatus 1 may conduct control based on the grouped instructions. The remote-control control apparatus 1 may also record a history of the given instructions for each user. Specifically, for example, in a case where information of data files can be displayed on the display device 4 in accordance with instructions from the remote control 3, the information to be displayed on the display device 4 can be restricted for each user.

Further, in the present embodiment, if the remote control 3 held by the user is not an unassociated remote control but an in-use remote control, no user may be assigned to the held remote control 3. Therefore, no new user will be assigned to a remote control 3 already used by any other user.

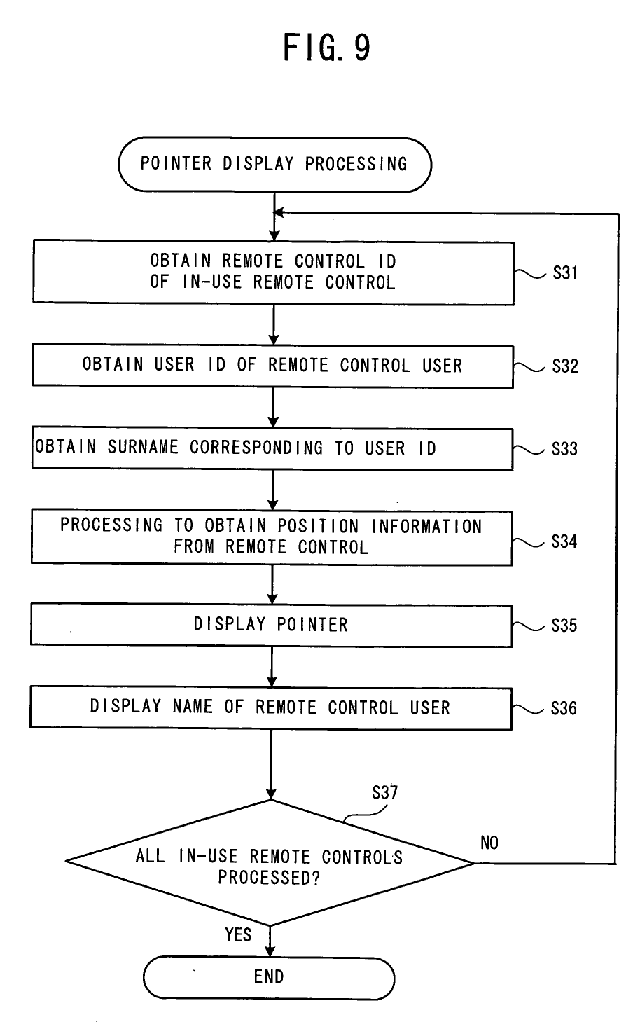

Next, pointer display processing will be described with reference to FIG. 9. The pointer display processing is performed when the CPU 10 in the remote-control control apparatus 1 executes a program to display a pointer. The pointer display processing starts at predetermined intervals (for example, at 20-millisecond intervals). In other words, the pointer display processing is performed repeatedly as long as the remote-control control apparatus 1 is active.

First, the remote-control association information storage area 141 is referred to, to obtain a remote control ID of an in-use remote control with which a user ID is associated (S31). The remote control ID obtained at step S31 is hereinafter referred to as a “processing remote control ID”. Then, the user ID associated with the processing remote control ID is obtained from the remote-control association information storage area 141 (S32). The user ID obtained at step S32 is hereinafter referred to as a “processing user ID”. Then, the surname of the user corresponding to the processing user ID is obtained from the server 2 (S33). Specifically, surname request information containing the processing user ID is transmitted to the server 2. When the server 2 receives the surname request information, the server 2 reads out the surname associated with the processing user ID from the user information storage area 241 and transmits the surname to the remote-control control apparatus 1 as surname response information. Thus, by receiving the surname response information, the remote-control control apparatus 1 can obtain the surname corresponding to the processing user ID. Not only the surname but also a given name may also be obtained. In such a case, the surname and given name can be used later to display a full name.

Subsequently, processing is performed to obtain position information of the remote control 3 identified by the processing remote control ID (S34). Specifically, among the position information pieces and the remote control IDs received from the remote controls 3, the position information received together with the processing remote control ID is obtained. According to a known method, a position indicated on a screen of the display device 4 is calculated from the position information, and a pointer is displayed at the position (S35). In the vicinity of the pointer, the surname obtained at step S33 is displayed (S36). Subsequently, it is determined whether all the in-use remote controls have been subjected to the processing of steps S31 through S36 (S37). If any one of the in-use remote controls has not been processed (NO at S37), the processing returns to step S31. Another remote control ID of the in-use remote control that has not been processed is obtained (S31), and processing to display the pointer is performed (S32 to S36). The processing of steps S31 through S37 is repeatedly performed until all the in-use remote controls have been processed (YES at S37), whereupon the pointer display processing ends.

In such a manner, the remote-control control apparatus 1 can identify which one of the users has given instructions from the remote control 3 the user is using. Based on the instructions, the remote-control control apparatus 1 can display icons on the screen on the display of the display device 4 in such a manner that it can be identified as to which icon is displayed in response to which user's instructions. Therefore, the users who are watching the display device 4 can know which one of the users has given the instructions with the remote control 3 to perform the current processing. In particular, in a case where the surnames or the full names of the users currently using the remote controls 3 are displayed in the vicinity of the pointers, the users watching the display device 4 may find it easy to recognize which one of the users is operating which one of the pointers.

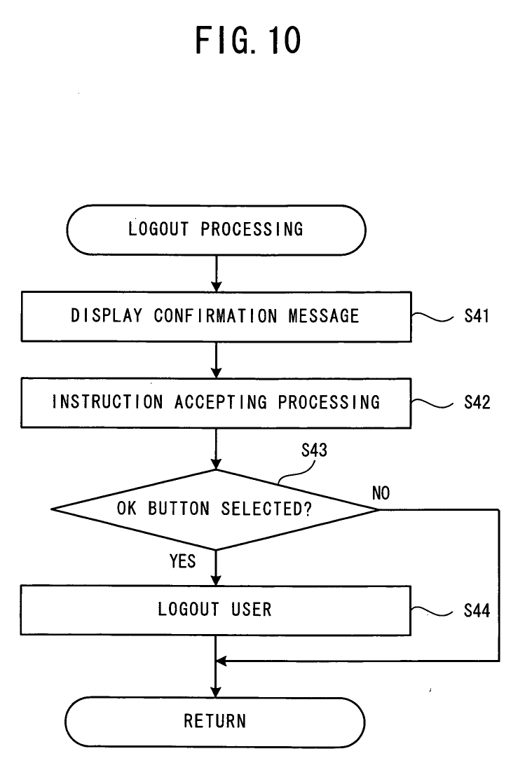

Next, logout processing will be described with reference to FIG. 10. The logout processing is performed by the CPU 10 in the remote-control control apparatus 1 executing a logout program. The logout processing starts when the DETERMINE button 37 is pressed while the pointer is positioned on the LOGOUT button 112 on a screen displayed on the display of the display device 4. Specifically, in a case where a determination signal that includes information indicating pressing of the DETERMINE button 37 and position information indicating a position pointed by the remote control 3 is transmitted from the remote-control control apparatus 1, and the LOGOUT button 112 is displayed at the position indicated by the position information, the logout processing is performed on the remote control 3 that has transmitted the determination signal.

First, on the display of the display device 4, for example, a confirmation message saying “READY TO LOGOUT?”, a remote control ID of the remote control 3 that has given the logout instructions, a user ID corresponding to the remote control ID, a surname of a user identified by the user ID, an OK button, and a CANCEL button are displayed (S41). Then, instruction accepting processing is performed (S42). Specifically, the determination signal from the remote control 3 that has given the logout instructions is awaited for a predetermined time (for example, one minute). If the determination signal that indicates the remote control 3 is pointed at the position of the OK button is received from the remote control 3 within the predetermined time, it is determined that OK button is selected (YES at S43).

In such a case, processing to logout a user is performed (S44). Specifically, in the remote-control association information storage area 141, the user ID associated with the remote control ID of the remote control 3 that has given the logout instructions is cleared. Furthermore, logout information indicating that the user ID is logging out is transmitted to the server 2. When the server 2 receives the logout information, the server 2 changes the user's login status, which was stored as “ON” in the user information storage area 241, to “OFF”. If the determination signal is not received within the predetermined time, or a determination signal that indicates the remote control 3 is pointed at the position of the CANCEL button is received, it is determined that OK button is not selected (NO at S43). In such a case, the logout processing ends.

If the logout instructions from the remote control 3 is received in such a manner, the login state is canceled.

The remote-control control apparatus 1, the server 2, the remote controls 3, and the variety of programs are not limited to the above-described embodiment and, of course, can be modified variously without departing from the gist of the present disclosure. For example, two electronic devices, i.e. the remote-control control apparatus 1 and the server 2 are connected to each other via the network 5 in the embodiment. However, the two electronic devices may be configured as one integrated electronic device. Further, for example, if the remote-control control system 100 is used in a remote meeting, a plurality of the remote-control control apparatus 1 may be employed. In such a case, a first remote-control control apparatus 1 installed at a certain place may be equipped with a plurality of the remote controls 3, while a second remote-control control apparatus 1 installed at another place may also be equipped with a plurality of the remote controls 3. The first and the second remote-control control apparatuses 1 may be each connected to the server 2 via the network 5. The same screen may appear on the display devices 4 respectively connected to the first and the second remote-control control apparatuses 1. On either screen of both of the display devices 4, pointers of the remote controls 3 of the first remote-control control apparatus 1 and pointers of the remote controls 3 of the second remote-control control apparatus 1 are both displayed. In such a case, as with the embodiment described above, the surnames of the users using the remote controls 3 may be displayed in the vicinity of the pointers, respectively.

Although only the surname is displayed beside the pointer in the embodiment described above, the full name may be displayed. Further, the user ID itself may be displayed, instead of the name of the user. In such a case, the user ID stored in the remote-control association information storage area 141 can be displayed as it is. Therefore, with a simple processing, the user watching the display device 4 can know which one of the users has given instructions for the processing currently performed. Also, any other user information may be displayed. For example, as shown in FIG. 6, in a case where the department is stored as the user information, the department can be displayed. Further, an image may be registered for each user, and the image may be displayed.

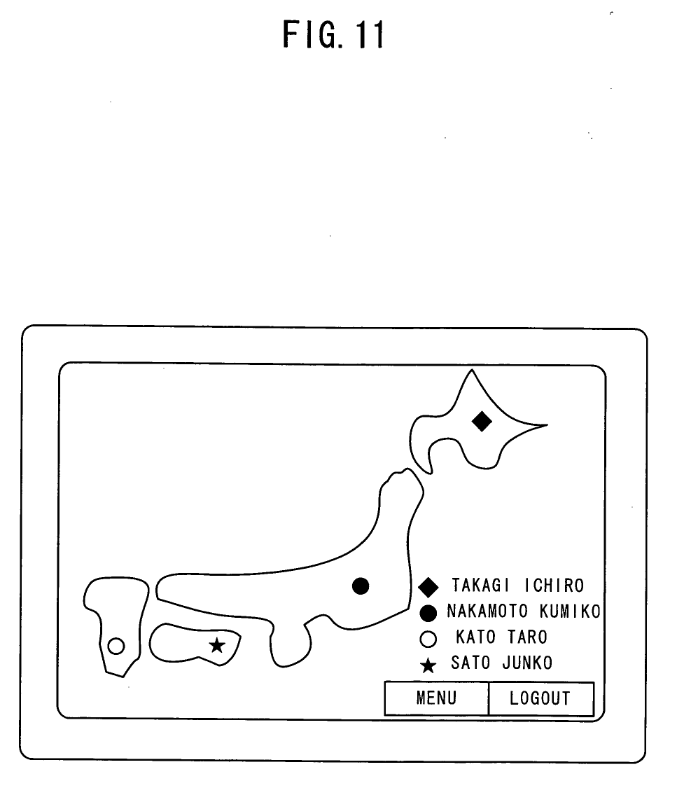

Further, as shown in FIG. 11, the user information may be displayed not only in the vicinity of the pointer, but also at any other places on the screen in such a manner that the relationship between the user information and the pointer can be identified. In the example shown in FIG. 11, the shapes of the pointers are different so that the pointers can be identified one another. In addition, names and patterns each having the same shape as each of the pointers are displayed in the lower right region of the screen. The pointers may be colored differently so that the pointers can be identified one another.

In the embodiment described above, the ID card storing a user ID is equipped with an RFID tag. However, a storage medium of the user ID and a method of reading the user ID by the remote-control control apparatus 1 are not limited to the RFID tag and reading the RFID tag with a card reader, respectively. The user ID may be stored in a magnetic card. Information printed in bar codes may be read. Further, although the embodiment is described with reference to examples of giving instructions to display a pointer on the screen and to logout by using the remote control 3, the instructions from the remote control 3 are not limited to these examples.

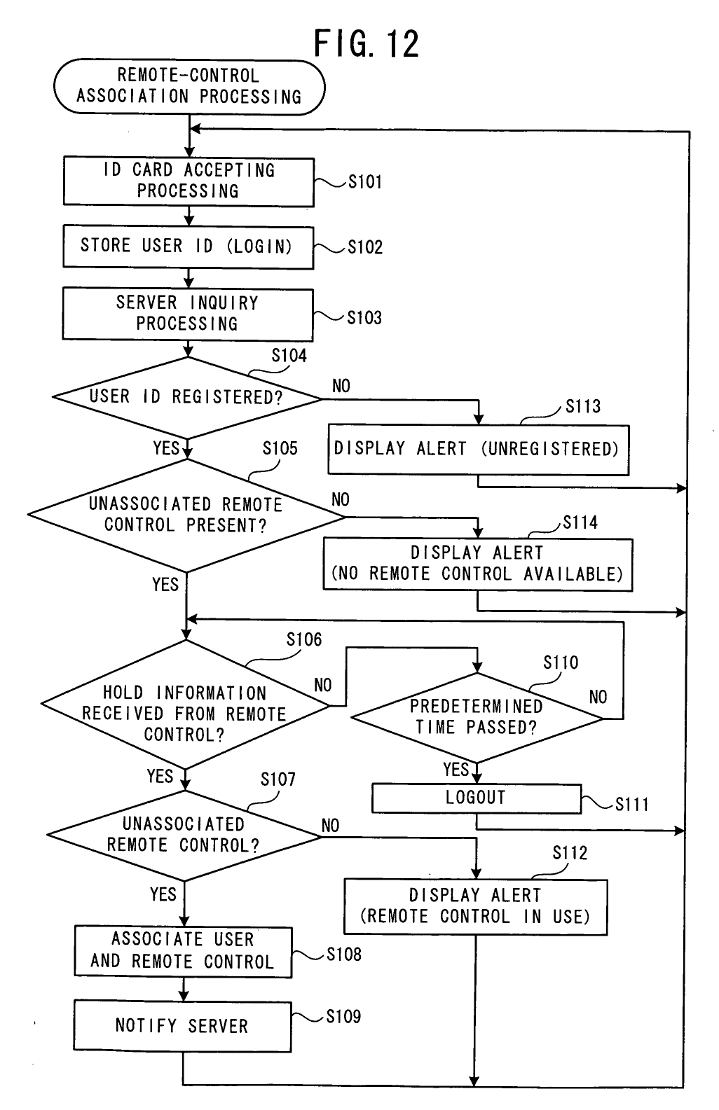

In the embodiment described above, the user ID is obtained from the user card 6, an unassociated remote control is associated with a user having the obtained user ID, the user is notified of the unassociated remote control, and the login process is completed when the notified remote control is held by the user. However, the user need not be notified of the unassociated remote control. For example, as shown in a flowchart of FIG. 12, a remote control 3 that is held first after the user ID is obtained from the user card 6 may be associated with the user. More specifically, the user causes the remote-control control apparatus 1 to read a user card 6 of the user, and then picks up a desired remote control. If the held remote control is an unassociated remote control, the remote control is associated with the user. If the held remote control is not an unassociated remote control, an alert appears. Accordingly, the user causes the remote-control control apparatus 1 to read the user card again, and picks up another remote control. Such a processing will be described below. It is to be noted that processing at the steps S101 through S105, S113, and S114 of the flowchart shown in FIG. 12 are the same as processing at the respective steps S1 through S5, S13, and S14 of the remote-control association processing of the embodiment shown in FIG. 8. Therefore, explanation on these steps will be omitted, and different parts of the processing will be mainly described.

If a user ID is obtained from the user card 6 and there is an unassociated remote control available (YES at S105), it is determined whether the hold information is received from the remote control 3 (S106). If the hold information is not received, it is repeatedly determined whether the hold information is received for a predetermined time (NO at S106, NO at S110). If the hold information is received (YES at S106), it is determined whether the remote control 3 that has transmitted the hold information is an unassociated remote control (S107). A user ID associated with a remote control ID included in the hold information is referenced from the remote-control association information storage area 141. If the user ID is stored, the remote control 3 is not an unassociated remote control (NO at S107). Then, a message saying “HELD REMOTE CONTROL IS IN USE”, for example, appears as an alert (S112). Then, the processing returns to step S101. If the user ID associated with the remote control ID included in the hold information is not stored in the remote-control association information storage area 141, the remote control 3 is an unassociated remote control (YES at S107). In such a case, the user ID is associated with the remote control 3 that transmitted the hold information and stored in the remote-control association information storage area 141 (S108). Thus, the user ID is associated with the notified remote control, and use information indicating that the notified remote control has entered the in-use state is transmitted to the server 2 (S109). When the server 2 receives the use information, the server 2 turns changes the login status of the relevant user, which was stored as “OFF” in the user information storage area 241, to “ON”.

As described above, after the user ID is obtained from the user card 6, the remote control 3 held by the user is assigned for use by the user having the obtained user ID. Accordingly, the user can use a desired remote control 3, if the remote control is an unassociated remote control.

Further, in a modified embodiment shown in FIG. 12, at step S107, without determining whether the held remote control is an unassociated remote control, the remote control 3 may be associated with the user who has held the remote control 3. In such a case, if the user wishes to use a remote control 3, the user may only cause the user ID stored in the user card 6 to be read and pick up a desired remote control 3. Thus, the user can be associated with the remote control 3 as its user.

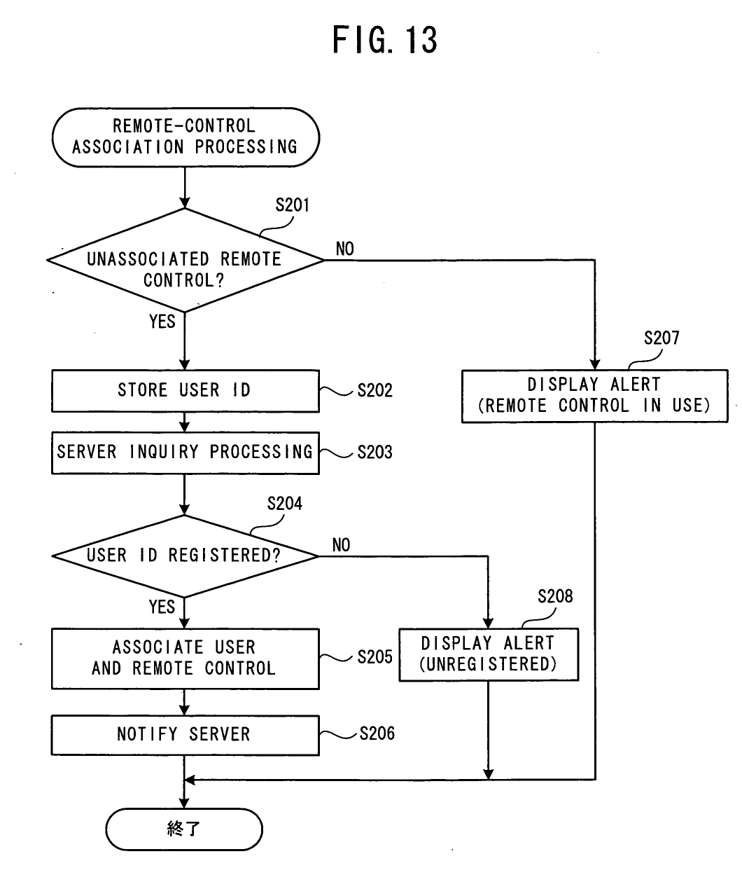

In the embodiments described above, the user card 6 is read by the remote-control control apparatus 1 and a user ID is obtained. Instead, the remote control 3 may be equipped with the card reader 13 so that the user ID can be obtained in the remote control 3. Another modified embodiment, in which a user ID is obtained in the remote control 3, will be described with reference to FIG. 13. The card reader 13 in the remote control 3 outputs an interrogation wave periodically. If the user card 6 is present in an effective range of the interrogation waves, the card reader 13 receives a wave reflected by the RFID tag in the user card 6. From the reflected wave thus received, the user ID that was stored in the RFID tag beforehand is extracted, and information including the extracted ID is output from the output portion 35 of to the remote-control control apparatus 1. When the remote-control control apparatus 1 receives the information, the remote-control association processing of the modified embodiment shown in FIG. 13 is performed by the CPU 10 of the remote-control control apparatus 1. The remote control 3 that has output the information including the user ID is hereinafter referred to as an “output remote control”.

First, it is determined whether the output remote control is an unassociated remote control (S201). If the user ID associated with the remote control ID of the output remote control is stored in the remote-control association information storage area 141, the output remote control is not an unassociated remote control (NO at S201). Then, a message saying “REMOTE CONTROL IS IN USE”, for example, appears as an alert (S207) and the processing terminates. If the user ID is not stored in the remote-control association information storage area 141 corresponding to the remote control ID of the output remote control, the output remote control is an unassociated remote control (YES at S201). Accordingly, the user ID received from the output remote control is stored in a predetermined storage area of the RAM 12 as an accepted user ID (S202).

Then, processing is performed to make inquiry to the server 2 as to whether the accepted user ID is already registered (S203). If a response from the server 2 indicates that the accepted user ID is not registered (NO at S203), a message saying “USER ID IS NOT REGISTERED”, for example, appears as an alert on the display device 4 (S208). If the response from the server 2 indicates that the accepted user ID is registered (YES at S203), the accepted user ID is stored in the remote-control association information storage area 141 as the user ID associated with the output remote control (S205). Thus the accepted user ID is associated with the notified remote control, and use information indicating that the notified remote control has entered the in-use state is transmitted to the server 2 (S206). When the server 2 receives the use information, the server 2 changes the login status of the relevant user, which was stored as “OFF” in the user information storage area 241, to “ON”.

In such a manner, even in a case where the user ID is obtained by the remote control 3, the remote control 3 and the user can be associated with each other in the remote-control control apparatus 1.

What is claimed is:

1. An electronic device that accepts instructions from remote controls, comprising:
a user identification information obtaining device that obtains user identification information to identify a user from a user identification information storage medium that stores the user identification information;
a remote control user storage device that stores the user identification information of remote control users respectively associated with remote control identification information of the remote controls, the remote control users respectively using the remote controls, and the remote control identification information identifying each of the remote controls; and
an association device that stores the user identification information obtained by the user identification information obtaining device into the remote control user storage device in a condition where the obtained user identification information is associated with the remote control identification information of any one of the remote controls.

2. The electronic device according to claim 1, further comprising:
a hold information obtaining device that obtains hold information from any one of the remote controls, the hold information indicating that the any one of the remote controls is held,
wherein the association device stores the user identification information obtained by the user identification information obtaining device in a condition where the obtained user identification information is associated with the remote control identification information of a held remote control, the held remote control being the any one of the remote controls that has transmitted the hold information obtained by the hold information obtaining device.

3. The electronic device according to claim 2, further comprising:
a notification device that notifies of an unassociated remote control when the user identification information is obtained by the user identification information obtaining device, the unassociated remote control being any one of the remote controls that has the remote control identification information stored in the remote control user storage device that is not associated with any user identification information,
wherein the association device stores the user identification information obtained by the user identification information obtaining device into the remote control user storage device in a condition where the obtained user identification information is associated with the remote control identification information of the held remote control, if the held remote control is the unassociated remote control.

4. The electronic device according to claim 2, wherein the association device stores the user identification information obtained by the user identification information obtaining device into the remote control user storage device in a condition where the obtained user identification information is associated with the remote control identification information of the held remote control, only if the held remote control is an unassociated remote control, the unassociated remote control being any one of the remote controls that has the remote control identification information stored in the remote control user storage device that is not associated with any user identification information.

5. The electronic device according to claim 1, further comprising:
a hold information obtaining device that obtains hold information from any one of the remote controls, the hold information indicating that the any one of the remote controls is held,
wherein:
the user identification information obtaining device obtains the user identification information, if no user identification information is associated with the remote control identification information of a held remote control, the held remote control being the any one of the remote controls that has transmitted the hold information obtained by the hold information obtaining device; and
the association device stores the user identification information obtained by the user identification information obtaining device into the remote control user storage device in a condition where the obtained user identification information is associated with the remote control identification information of the held remote control.

6. The electronic device according to claim 1, further comprising:
a display device that displays information;
an instruction obtaining device that obtains the remote control identification information and instruction information which indicates instructions to the electronic device from any one of the remote controls; and
a display control device that causes the display device to display either information based on the user identification information or the user identification information stored in the remote control user storage device as associated with the remote control identification information obtained by the instruction obtaining device, according to the instructions indicated by the instruction information.

7. The electronic device according to claim 6, wherein the display control device causes the display device to display user information associated with the user identification information obtained by the user identification information obtaining device as the information based on the user identification information, the user information being information of a user and being stored in a user information storage device that stores the user information associated with the user identification information.

8. The electronic device according to claim 7, wherein:
the user information is a name of the user; and
the display control device causes the display device to display the name.

9. The electronic device according to claim 6, wherein:
the instruction information indicates instructions to cause the display device to display a pointer and contains position information which indicates a position where the pointer is to be displayed; and
the display control device causes the display device to display the pointer at the position indicated by the position information and to display the user identification information or the information based on the user identification information in such a manner that the pointer and the user identification information or the information based on the user identification information can be associated with each other.

10. The electronic device according to claim 1, further comprising:
a login control device that puts a user that is identified by the obtained user identification information in a login state, when the user identification information is obtained by the user identification information obtaining device; and
a logout control device that cancels the login state of the user.

11. A remote control comprising an instruction output device that gives instructions to the electronic device according to claim 1.

12. A computer-readable medium storing a program to control an electronic device equipped with remote controls, the program comprising instructions to cause a controller of the electronic device to perform the steps of:
obtaining user identification information to identify a user; and
storing the obtained user identification information into a remote control user storage device in a condition where the obtained user identification information is associated with remote control identification information of any one of the remote controls, the remote control user storage device storing the user identification information of remote control users respectively associated with the remote control identification information of the remote controls, the remote control users respectively using the remote controls, and the remote control identification information identifying each of the remote controls.

13. The computer-readable medium according to claim 12, wherein:
the program further comprises instructions to cause the controller to perform the step of obtaining hold information from any one of the remote controls, the hold information indicating that the any one of the remote controls is held; and
the step of storing the obtained user identification information stores the obtained user identification information in a condition where the obtained user identification information is associated with the remote control identification information of a held remote control, the held remote control being the any one of the remote controls that has transmitted the obtained hold information.

14. The computer-readable medium according to claim 13, wherein:
the program further comprises instructions to cause the controller to perform the step of notifying of an unassociated remote control when the user identification information is obtained, the unassociated remote control being any one of the remote controls that has the remote control identification information stored in the remote control user storage device that is not associated with any user identification information; and
the step of storing the user identification information stores the obtained user identification information into the remote control user storage device in a condition where the obtained user identification information is associated with the remote control identification information of the held remote control.

15. The computer-readable medium according to claim 13, wherein the step of storing the user identification information stores the obtained user identification information into the remote control user storage device in a condition where the obtained user identification information is associated with the remote control identification information of the held remote control, only if the held remote control is an unassociated remote control, the unassociated remote control being any one of the remote controls that has the remote control identification information stored in the remote control user storage device that is not associated with any user identification information.

16. The computer-readable medium according to claim 12, wherein:
the program further comprises instructions to cause the controller to perform the step of obtaining hold information, the hold information indicating that any one of the remote controls is held;
the step of obtaining the user identification information obtains the user identification information, if no user identification information is associated with the remote control identification information of a held remote control, the held remote control being the any one of the remote controls that has transmitted the obtained hold information obtained; and
the step of storing the user identification information stores the obtained user identification information into the remote control user storage device in a condition where the obtained user identification information is associated with the remote control identification information of the held remote control.

17. The computer-readable medium according to claim 12, wherein the program further comprises instructions to cause the controller to perform the steps of:
obtaining the remote control identification information and instruction information which indicates instructions to the electronic device from any one of the remote controls; and
displaying either information based on the user identification information or the user identification information stored in the remote control user storage device as associated with the obtained remote control identification information, according to the instructions indicated by the instruction information.

18. The computer-readable medium according to claim 17, wherein the step of displaying either the information based on the user identification information or the user identification information displays user information associated with the obtained user identification information as the information based on the user identification information, the user information being information of a user and being stored in a user information storage device that stores the user information associated with the user identification information.

19. The computer-readable medium according to claim 18, wherein:
the user information is a name of the user; and
the step of displaying either the information based on the user identification information or the user identification information displays the name.

20. The computer-readable medium according to claim 17, wherein:
the instruction information indicates instructions to display a pointer and contains position information which indicates a position where the pointer is to be displayed; and
the step of displaying either the information based on the user identification information or the user identification information displays the pointer at the position indicated by the position information and displays the user identification information or the information based on the user identification information in such a manner that the pointer and the user identification information or the information based on the user identification information can be associated with each other.

21. The computer-readable medium according to claim 12, wherein the program further comprises instructions to cause the controller to perform the steps of:
putting a user that is identified by the obtained user identification information in a login state, when the user identification information is obtained; and cancelling the login state of the user.
